(19) United States
(12) Patent Application Publication
(10) Pub. No.: US 2009/0271958 A1
(43) Pub. Date: Nov. 5, 2009

(54) Hook and Loop Strap with Loop Indicia

(76) Inventor: Chris Kirshbaum, Glendale, CA (US)

Correspondence Address: ITALIA IP, 3500 WEST OLIVE AVE., SUITE 300, BURBANK, CA, 91505, US

(21) Appl. No.: 12/435,938

(22) Filed: May 5, 2009

Related U.S. Application Data
(60) Provisional application No. 61/050,582, filed on May 5, 2008.

(51) Int. Cl. A44B 18/00; A44C 5/00; A01K 27/00

(52) U.S. Cl. 24/442; 63/1.11; 63/3; 119/856

(57) ABSTRACT

A hook and loop strap for attachment to an object and that is usable with loop indicia. The hook and loop strap has a first end, a second end, a top side surface area and a bottom side surface area, with all of the top side surface area being a hook portion. The loop indicia attached to the top side surface area of the strap has a means for attachment for the first end to the second end for attachment of the strap around the object and a second hook and loop fastener, with a second hook portion for attaching the loop indicia to the top side surface area.

### CROSS-REFERENCE TO RELATED APPLICATION

This application claims the benefit of the filing date under 35 USC 119(e) of the filing date of U.S. Provisional Application Ser. No. 61/050,582, filed May 5, 2008, the contents of which are incorporated herein by reference.

### BACKGROUND

This application relates generally to a hook and loop strap for attachment to an object that attaches each end of itself with a hook and loop fastener. More specifically, this application relates to a hook and loop strap used in combination with loop indicia that are attached to this type of hook and loop strap also with a hook and loop fastener arrangement.

### SUMMARY

People will always find ways and means to express themselves and their specific ideas and beliefs. One of the most popular ways of doing this is through wearing clothing and jewelry that will have various indicia such as written messages, images and pictures that reflect the ideas and beliefs of the person wearing the clothing or jewelry. Clothing and jewelry that can provide a person a way of expressing themselves in a fast, easy, non-permanent and inexpensive fashion would be very valuable to that person. Also clothing and jewelry that can be worn in many different ways such as a bracelet, a necklace or as an accoutrement on a backpack, a lunchbox, a belt loop or a wallet chain would also be greatly desired. Therefore, there is a significant need for a piece of jewelry that is extremely flexible, easy and versatile to use, such as a hook and loop strap with a wide variety of indicia that also utilizes hook and loop fasteners to attach to the hook and loop strap.

This application discloses a hook and loop strap that enables a wearer to express his or her specific ideas and beliefs with great versatility in a fast, easy, non-permanent and inexpensive fashion.

In particular, this application discloses a hook and loop strap for attachment to an object and that is usable with loop indicia. The hook and loop strap has a first end, a second end, a top side surface area and a bottom side surface area, with all of the top side surface area being a hook portion. The loop indicia attached to the top side surface area of the strap has a means for attachment of the first end to the second end for attachment of the strap around the object and a second hook and loop fastener, with a second hook portion attaching the loop indicia to the top side surface area.

### BRIEF DESCRIPTION OF THE DRAWINGS

The drawings, when considered in connection with the following description, are presented for the purpose of facilitating an understanding of the subject matter sought to be protected.

FIG. 1 is an environmental perspective view of a first embodiment of a hook and loop strap with loop indicia.

FIG. 2a is an exploded perspective view of the hook and loop strap in an unattached position.

FIG. 2b is a front perspective view of the hook and loop strap in an attached position.

FIG. 3a is an exploded perspective view of loop indicia being unattached to the hook and loop strap.

FIG. 3b is a front perspective view of loop indicia being attached to the hook and loop strap.

### DETAILED DESCRIPTION

While the hook and loop strap with loop indicia present is described with reference to several illustrative embodiments described herein, it should be clear that the present invention should not be limited to such embodiments. Therefore, the description of the embodiments provided herein is illustrative of the present invention and should not limit the scope of the invention as claimed. In addition, while following description references for a hook and loop strap with loop indicia, it will be appreciated that the invention may be any hook and loop strap with loop indicia.

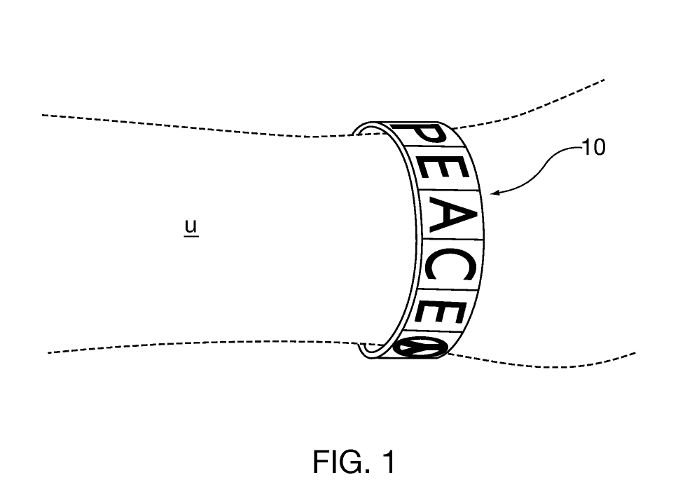

Referring now to FIG. 1, a first embodiment of a hook and loop strap with loop indicia 10 being worn by a user U is shown. The hook and loop strap with loop indicia 10 is typically worn around a user's U wrist, but can also be used as an ankle bracelet around a user's U ankle (not shown). The hook and loop strap with loop indicia 10 can also be used as a dog collar, a mood bracelet, an emergency bracelet, a small necklace or as an accoutrement on a backpack, a lunchbox, a belt loop, a wallet chain or with any other venue in which a message to the world is desired to be expressed (also not shown).

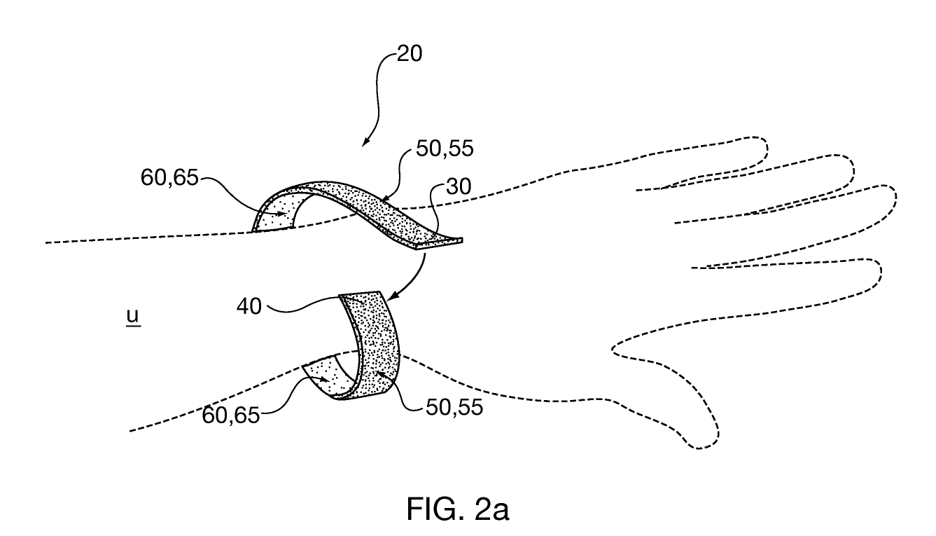

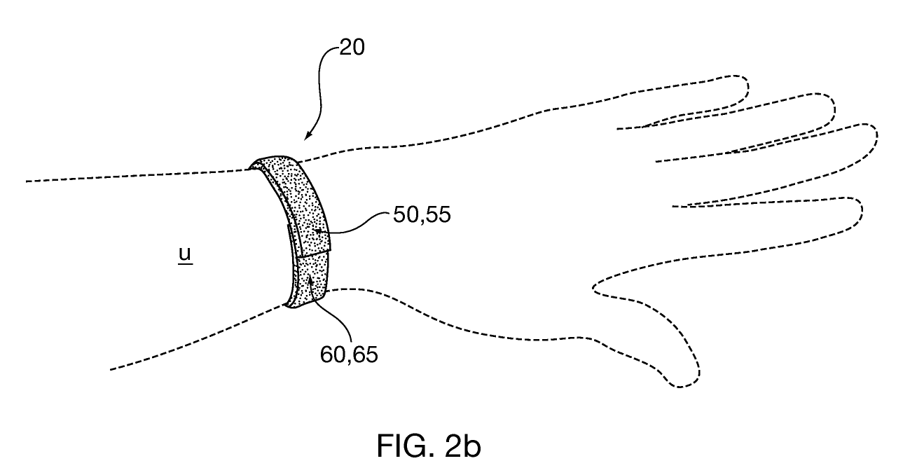

Referring now to FIG. 2a and FIG. 2b, the hook and loop strap with loop indicia 10 can be used to express a user's specific ideas and beliefs. The hook and loop strap with loop indicia 10 has a hook and loop strap portion 20 that is wrapped around a user's U wrist, having a first end 30 and a second end 40, a top side surface area 50 and a bottom side surface area 60. Note that the hook and loop strap with loop indicia 10 can also accommodate other objects and body parts as well. The entire hook and loop strap portion 20 is a strip of 2-sided VELCRO or a 2-sided strip-shaped hook and loop fastener, with the entire top side surface area 50 being the first hook portion 55 and the entire bottom side surface area 60 being the first loop portion 65, attaching the first end 30 and the second end 40 around the user's wrist anywhere along the top side surface area 50 and the bottom side surface area 60 for securing the hook and loop strap portion 20 around a user's U wrist. This is just one type of means for attachment to an object. The hook and loop strap portion 20 can have different colors on either side so it can be worn with either side facing outward. It is also important to note that the hook and loop strap portion 20 is made entirely of non-elastic material and is made of no elastic material. FIG. 2a shows the hook and loop strap portion 20 in an unattached or unsecured position while FIG. 2b shows the hook and loop strap portion 20 in an attached or secured position.

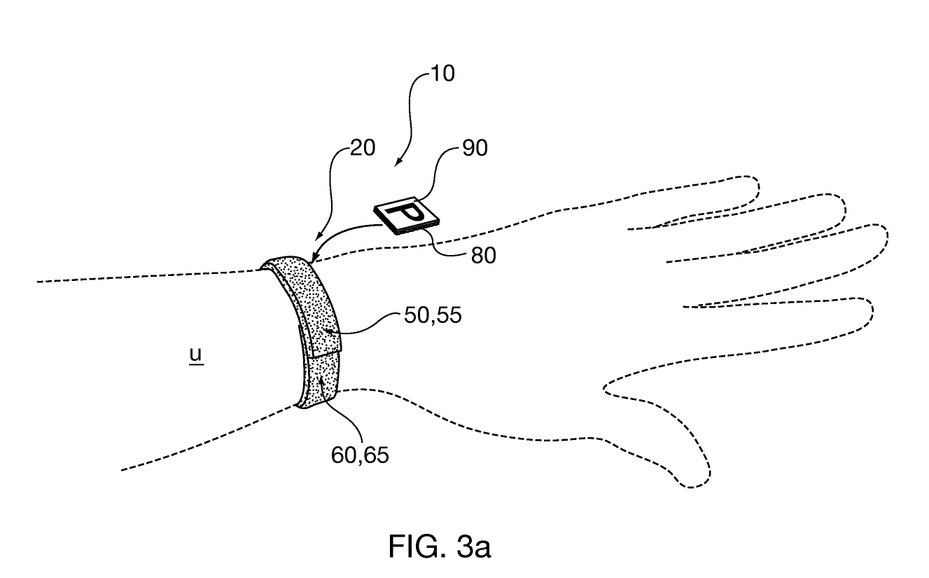

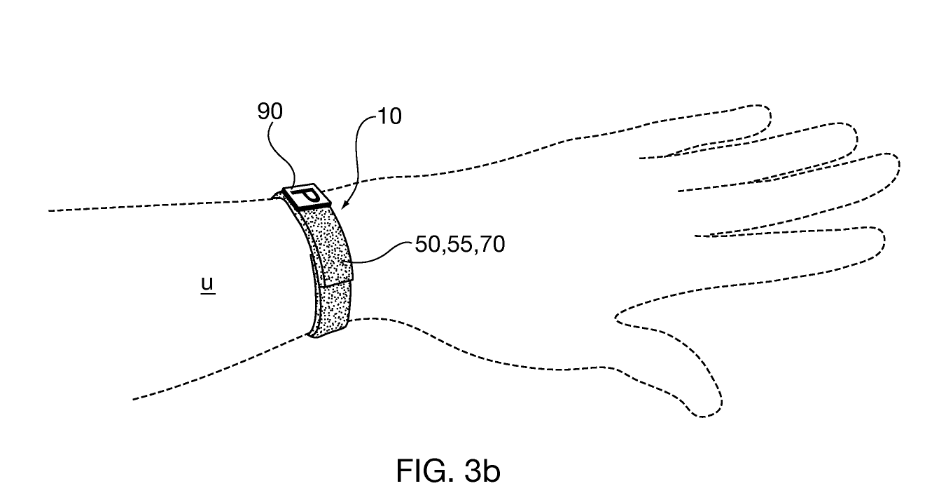

Referring now to FIG. 3a and FIG. 3b, a second hook and loop fastener (no number) is formed with a second hook portion 70 and a second loop portion 80, attaching the loop indicia 90 to the top side surface area 50. Note that the top side surface area 50, the first hook portion 55 and the second hook portion 70 refer to anywhere on the same area. The second loop portion 80 is situated on the underside of the loop indicia 90 and cannot be attached to the bottom side surface area 60 or first loop portion 65, since both are loop portions that cannot physically couple or attach. The loop indicia 90 can be individual letters, numbers and symbols and are square shaped. FIG. 3a, shows the loop indicia 90 separated from the top side surface area 50 while FIG. 3b shows the loop indicia 90 attached to the top side surface area 50. A plurality of loop indicia 90 can be attached to the top side surface area 50, as long as there is enough physical space on the top side surface area 50 for the plurality of loop indicia 90 to couple with the top side surface area 50.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A hook and loop strap for attachment to an object and usable with loop indicia, comprising:
a hook and loop strap, having a first end, a second end, a top side surface area and a bottom side surface area, wherein all of said top side surface area is a hook portion;
loop indicia attached to said top side surface area of said strap;
a means for attachment of said first end to said second end for attachment of said strap around said object;
a second hook and loop fastener, with a hook portion for attaching said loop indicia to said top side surface area.

2. The strap according to claim 1, wherein said hook and loop strap is non-elastic.

3. The strap according to claim 1, wherein said hook and loop strap is a dog collar, a mood bracelet, an emergency bracelet and a small necklace.

4. The strap according to claim 1, wherein said hook and loop strap is an accoutrement on a backpack, a lunchbox, a belt loop and a wallet chain.

5. The strap according to claim 1, wherein all of said bottom side surface is a loop portion of said hook and loop strap.

6. The strap according to claim 1, wherein said loop indicia has a bottom surface of loops.

7. The strap according to claim 1, wherein said loop indicia has a top surface for individual letters, numbers and symbols.

8. The strap according to claim 7, wherein said individual letters, numbers and symbols are square shaped.

9. The strap according to claim 1, wherein said means for attachment is a hook and loop fastener.

10. The strap according to claim 1, wherein said bottom side surface area is entirely made up of a plurality of loops.

11. The strap according to claim 1, wherein said bottom side surface area is a partially made up of a plurality of loops.

12. The strap according to claim 11, wherein said bottom side surface area is made up of a plurality of loops at said second end.

13. A hook and loop strap for attachment to an object with loop indicia, comprising:
a hook and loop strap, having a first end, a second end, a top side surface area and a bottom side surface area, wherein all of said top side surface area is a hook portion;
loop indicia attached to said top side surface area of said strap;
a means for attachment of said first end to said second end for attachment of said strap around said object;
a second hook and loop fastener, with a hook portion for attaching said loop indicia to said top side surface area.

14. The strap according to claim 13, wherein all of said bottom side surface area is a loop portion of said hook and loop strap.

15. The strap according to claim 13, wherein said loop indicia has a bottom surface of a plurality of loops.

16. The strap according to claim 13, wherein said loop indicia has a top surface for individual letters, numbers and symbols.

17. The strap according to claim 16, wherein said individual letters, numbers and symbols are square shaped.

18. The strap according to claim 13, wherein said means for attachment is a hook and loop fastener.

19. The strap according to claim 13, wherein said bottom side surface area is entirely made up of a plurality of loops.

20. The strap according to claim 13, wherein said strap is a non-elastic bracelet.
